(19) United States
(12) Patent Application Publication
(10) Pub. No.: US 2019/0225456 A1
(43) Pub. Date: Jul. 25, 2019

(54) CABLE DRUM CONSTRUCTION FOR MULTIPLE, HORIZONTAL, ARTICULATING PANEL DOOR ASSEMBLY

(71) Applicant: Raynor Mfg. Co., Dixon, IL (US)

(72) Inventor: Joel M. Bonnell, Dixon, IL (US)

(21) Appl. No.: 15/879,626

(22) Filed: Jan. 25, 2018

(51) Int. Cl. B65H 75/44; E05F 15/686

(52) U.S. Cl. CPC B65H 75/4415; E05Y 2900/106; E05F 15/686

(57) ABSTRACT

A drum construction for an overhead garage door lift assembly includes a spiral groove comprised of three connected sections each having a distinct sequence of radii to facilitate raising and lowering of a multi-panel garage door mounted on a track in a manner which avoids undesirable surface impact of the door upon closing and enhances torque energy for lifting from the closed position.

### BACKGROUND OF THE INVENTION

In a principal aspect the present invention relates to a cable drum construction for a multi-panel door lift assembly. Various types of buildings may include openings with doors for ingress and egress comprised of multiple, horizontal panels joined together by hinges and mounted on tracks to guide the articulating door panels between a closed position and an open position. To effect movement of the door panels between the open position and the closed position, various types of motorized lift assemblies are utilized. A common type of assembly provides that tracks mounted on the lateral sides of the opening support the panels vertically to close the opening. The tracks extend upwardly over the opening and horizontally to guide the panels and open the passage to the building. Assemblies of this type often include a shaft which is motorized to rotate and thereby activate cable drums mounted on the lateral sides of the opening to wind or unwind a cable on the drums attached to the door panels. The cables are thus attached on one or both lateral sides of the door panels and may thus be wound on drums to lift the door panels and move them along the tracks between the open and closed positions. Coil springs are often utilized in combination with the drum mechanisms to counterbalance the weight of the panels and thus supplement opening and closing of such door assemblies. Various patents disclose mechanisms of this nature, by way of example, the following patents: U.S. Pat. No. 9,127,492 B2 issued Sep. 8, 2015 and U.S. Pat. No. 7,343,958 issued Mar. 18, 2008.

The design of these mechanisms often need to be customized depending upon the size, shape, weight and other aspects of the panel door construction. The aforesaid patents address some of these concerns.

An issue which is not addressed is the problem of lowering the door and raising the door when it closely approaches or is initially raised from the closed position. For example, upon closing a multi-panel door of the type referenced, lowering of the door may cause damage to the bottom side of the door if the door engages the floor or surface due to the fact that the weight of the door may cause adverse impact. The door and lifting mechanism for the door may then suffer damage. The floor material into which the door may impact can be adversely affected. Over time the mechanism for closing the door may be damaged. The known prior art mechanisms for opening and closing such doors do not appear to address such issues, particularly during initial opening or closing of the door. Thus, there has developed a need for an improved lift assembly construction for the raising and lowering of such multi-panel doors, particularly those which have a heavy top panel and which may accelerate undesirably as they are lowered due to the effect of gravity on the door as it is lowered vertically toward the ground surface. Another issue is associated with lifting the door vertically on a vertical track that is of greater height than the door which is to be lifted. Increased torque may be required in such a circumstance to lift the door panels vertically.

### SUMMARY OF THE INVENTION

Briefly, the present invention comprises a unique and novel drum construction which cooperates with a cable that connects the drum to a bottom panel of a multi-panel door construction. The cable is wound in a spiral groove in the outer surface drum and when the door is in the lowered position, the cable generally extends from the base of the door to the drum in a manner wherein the cable is extended generally to its maximum length between the cable drum assembly and the closed door. That is, when the door is open, the cable will wind upon the cable drum and raise the door thereby maintaining the door in the full open position. Lowering of the door is effected by reversing the operation and rotating the drum and unwinding the cable in a controlled manner which lowers the door to a closed position compensating for the fact that the effective weight door will increase with respect to its inertia and orientation as it is lowered.

In this regard, in order to counteract the initial motion or acceleration of the door as it is closed, the drum is designed to wind or unwind the cables thereon in three separate sections. The three sections include a first section which is designed to increase initial torque on the cable to lift the door from the closed position. The first section of the drum thus includes a successively decreasing diameter or radius of the spiral cable groove slot in the drum which provides enough torque to initially lift the door from the closed vertical position, smoothly and uniformly. This is followed by a second section of the spiral cable groove which increases radius of the groove and thus the torque during a second phase of the raising of the door. The second section is joined to a uniform diameter third section of the cable spiral groove which applies generally uniform torque to complete the raising of the door from a closed position to an open position.

Perhaps more importantly, upon closing the door, the cable initially unwinds from the uniform third section of the cable groove. The third section provides uniform torque for controlled release of the door as the cable unwinds. As the door approaches the closed vertical position, the degree of the torque decreases as the cable unwinds from the lesser radius, second groove section. This is followed by unwinding of the cable from the first groove section described above wherein the groove radius is appropriately increased in order to slightly increase torque to slow the vertical downward movement of the descending vertical door immediately prior to engaging ground surface. Thus, lowering the door effected generally uniformly and with controlled deceleration thereto initially during the final stages of lowering of the door by deceleration during the final stage of moving the descending door to its closed position. This arrangement avoids impact of the door on a surface.

Thus, it is an object of the invention to provide a raised or lowered position wherein additional torque is provided during the initial raising of the door in a controlled manner and torque is also provided which precludes impact of the bottom of the door during lowering thereof in the door opening.

A further object of the invention is to provide an improved vertical garage door opening system, in particular, a simple and straightforward system which incorporates a unique design of a drum or drums which are used in combination with springs and other elements associated with such vertical garage door multi-panel constructions.

These and other objects, features and benefits are set forth hereinafter.

### BRIEF DESCRIPTION OF THE DRAWING

In the detailed description which follows, reference will be made to the drawing comprised of the following figures:

FIG. 1 is an isometric view of a typical multi-panel garage door construction wherein the upper panel is heavier than the individual remaining panels and which results in a disproportionally heavier load upon the door lift mechanism when initially raising the door;

FIG. 2 is a graph depicting an example of an aspect of the invention wherein the typical weight in pounds of a multi-panel garage door varies with respect to the height thereof illustrating the change in load associated when raising the garage door via movement along a mounting track for the garage door, a circumstance wherein the vertical height of the door is less than the vertical dimension of the track which guides the door between the open and closed condition;

FIG. 3 is a side elevation of a cable drum construction of the invention;

FIG. 4 is a cross sectional view of the cable drum of FIG. 3;

FIG. 5 is a cross sectional view of the cable drum construction of FIG. 3;

FIG. 6 is an isometric view of a cable drum construction for the left hand side of the door construction of FIG. 1; and

FIG. 7 is a isometric view of the cable drum construction for the right hand side of the door construction of FIG. 1.

### DESCRIPTION OF AN EMBODIMENT OF THE INVENTION

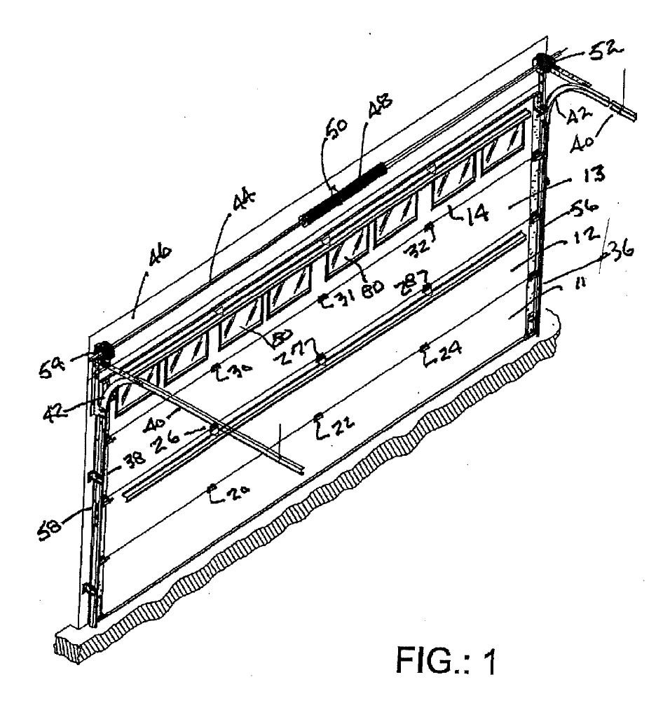

Referring to FIG. 1, there is depicted in an isometric view a typical overhead garage door assembly comprised of a series of horizontal panels 11, 12, 13, 14 connected by hinges such as hinges such as 20, 22, 24, 26, 27, 28, 30, 31, 32. The composite arrangement of the panels 11, 12, 13, 14 are depicted from the inside view of the door construction as arranged to provide an access opening upon raising the array of composite panels upwardly and inwardly guided by first and second multi-sectioned tracks 36, 38 positioned inside of a building such as a garage. Each of the tracks 36, 38 includes a vertical section or run 38 and a generally horizontal section or run 40 connected by an arcuate section or run 42 which guides wheels or rollers attached to the outside lateral sides of the panels 11, 12, 13, 14 on the opposite lateral sides thereof to guide the panels upwardly and into the building structure. The panels 11, 12, 13, 14 may be of different construction, materials and combinations of materials. For example, the panel 14 in FIG. 1 includes a series of windows 80. The composition and construction of the various panels thus provide a door construction which may vary in terms of materials and weight.

The door may be raised or lowered by means of a mechanism comprised of an axle or rod 44 rotationally mounted above the top panel 14 on a frame attached to a header or plate 46. The axle 44 may be mounted in a manner wherein it is affixed to a spring 48 which is mounted on the plate 46 by a bracket 50. The spring 48 thus provides a means to counterbalance the weight of the door construction.

A door lift mechanism further comprises first and second cable drums 52, 54 mounted on opposite ends and attached to the axle or rod 44 to rotate coaxially therewith. Each cable drum 52, 54 includes a spiral groove 74 designed to receive a cable such as cable 56 which is cooperative respectively with drum 52 and drum 54. One end of each cable 56, 58 is thus attached, respectively, to a cable drum 52, 54 associated therewith. Each cable 56, 58 winds upon or unwinds from the associated drum upon rotation of the axle or rod 44. The opposite end of each cable 56, 58 is attached to the lowest or lower panel 11. Thus, in order to raise the door from the closed position as depicted in FIG. 1, the rod or axle 44 will be rotated appropriately to wind the appropriate cable 56, 58 on the appropriate drum 52, 54. The winding and unwinding operation will involve rotating the axle or rod 44 in the appropriate rotational sense relative to raising and lowering the door panels. Thus, movement of the door may be effected by manually raising or lifting the spring counterbalanced panels comprising the door. Alternatively, a mechanical trolley attached to the top door panel 14 and powered by an electric motor may operate to raise or lower the multi-panel door. Also, the axle or rod 44 may be rotationally driven, for example, by an electric motor. Such opening of the door will thus move the panels 11, 12, 13, 14 from the vertical track 38 orientation upwardly along the arcuate tracks 42 and onto the horizontal tracks 40. The door panels thus move vertically upwardly and then horizontally. The upward movement is initially principally vertical in that the vertical run 38 of the tracks which is typically a few inches greater than the height of the assembled door panels. This arrangement facilitates movement of the door panels in a manner which enhances the seal between the door and the opening thereof.

When the door is in the lowered position as depicted in FIG. 1, the spring 48 is provided to compensate or counterbalance the door panel assembly in a manner wherein the amount of energy that must be utilized to raise the door panels from the vertical position to the storage position on the generally horizontal tracks is facilitated by the energy associated with the spring 48. Thus, the energy to raise and lower the door is, in part, compensated by the spring 48.

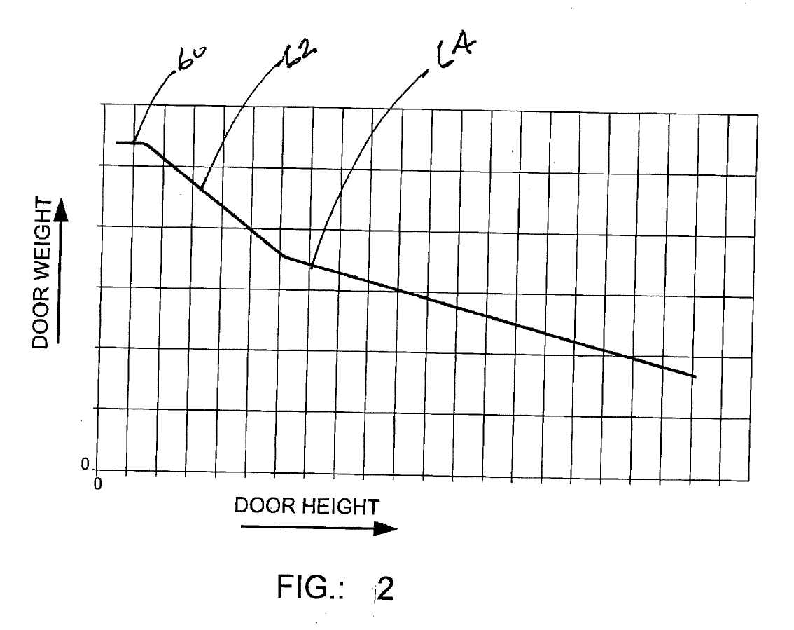

FIG. 2 illustrates the relationship between the weight of the door and the movement thereof from a vertical to a generally horizontal position. That is, initially, as depicted in the graph of FIG. 2, the weight of the door is static as represented by segment 60 of the graph. The effective weight of the door results because the vertical track thereof extends upwardly beyond the door opening and beyond the height of the door. Thus, the door must be lifted vertically initially and substantially the entire weight of the door must be addressed to effect movement upwardly upon entry into the arcuate section 42 of the track. The effective weight of the door diminishes as represented by section 62 of the graph of FIG. 2.

Ultimately, the door will be positioned so that a majority of the door and its associated weight will be positioned in a generally horizontal position as represented by section 64 of the graph of FIG. 2.

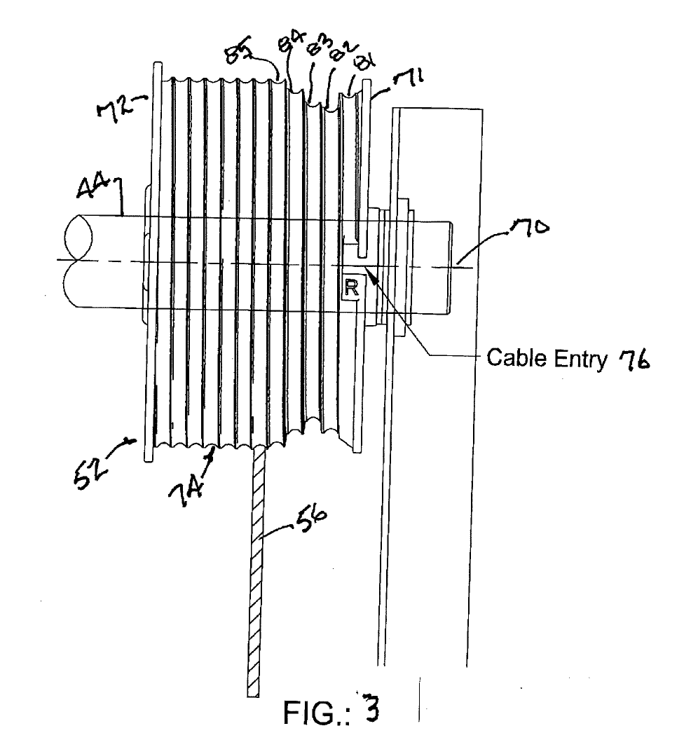

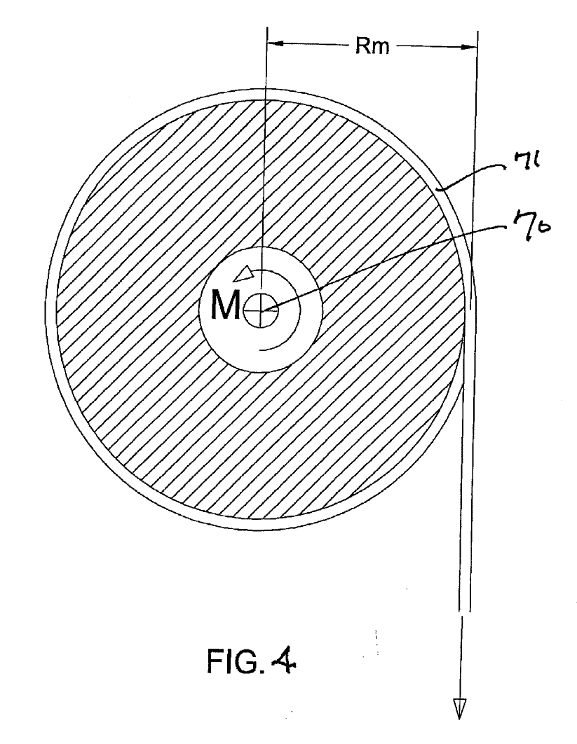

To accommodate the changes in the effective energy required to effectively and safely move the door between the open and closed position, the cable drums 52, 54 employ a customized design arrangement. FIG. 3 is an elevation view of one of the drums; namely, the drum 52 on the right hand side in FIG. 1. The drum 52 includes an axis of rotation 70 and is mounted on axle 44 as depicted in FIGS. 3 and 4. The drum 52 includes a first end flange 71 and second end flange 72 axially spaced from the first flange 71. A spiral slot or groove 74 is formed on the drum surface for receipt of a cable 56 to be wound thereon. One end of cable 56 is fitted into an attachment slot 76 and the cable 56 is wound in the groove 74. The groove 74 is defined by the dimension of the radius thereof and the changes in the dimension of the radius thereof. That is, referring to FIGS. 3 and 5, the groove is comprised of an initial radial dimension groove 81. That groove 81 has a variable radius which decreases to a lesser radius 82. The decrease is a uniform decrease as the groove 74 spirals axially away from the first flange 71. The groove 81 then reaches a minor radius and subsequently increases in radial dimension of groove 83. The increase in the radial dimension of the subsequent grooves further as depicted in groove 84. Groove 85 and all subsequent grooves extending axially from the first flange 71 are substantially equal up through or to the second flange 72.

In review, the spiral groove 74 is divided into three sections 60, 62, 64 as depicted in cross sectional FIG. 5. Section 1 (60) beginning at or near the first flange 71 and has an initial radius less than the radii of section 3 (64). The radii of section 1 (60) also decrease in the axial direction of second flange 72 to a minimum radius. Next adjacent section 2 (62) exhibits an increasing radial dimension as the groove extends axially toward the second flange 72. Section 3 (64) of the groove pattern maintains a substantially constant radius that is greater than the radius of the grooves of sections 1 (60) and 2 (62).

The arrangement thus supplies or provides a radius lesser in all instances than the final radial groove beginning with groove 85 but initially greater than an interim groove 82 and subsequently the radial grooves increase in radius up through groove 84. Thus, the grooves are divided into three component parts as illustrated in FIG. 5. A section 1 (60) resulting in a declining radius adjacent the first flange to a minimum radius followed by an increasing radius in section 2 (62) adjacent the, and connected to, the section 3 (64).

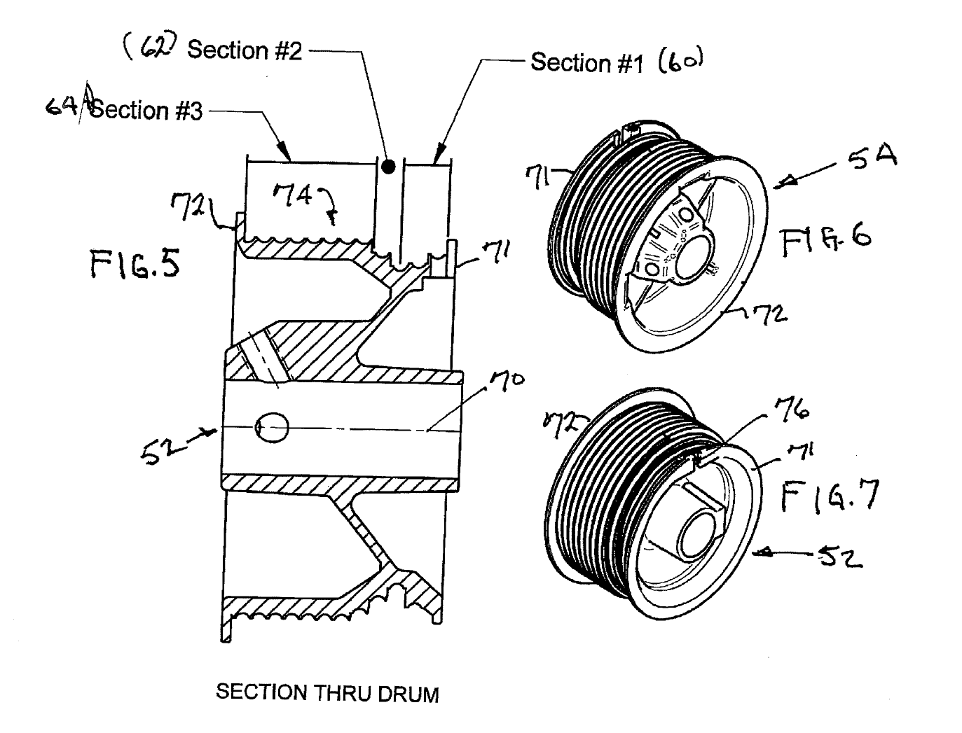

Both of the cable drums have the same arrangement, however, as depicted in FIGS. 6 and 7 the grooves spiral in opposition directions. That is, FIG. 6 depicts a so-called left hand drum as identified previously and FIG. 7 describes a right hand drum.

The separate sections of the cable drums correlate with the dimensions of the door height versus the door weight as depicted in FIG. 2. That is, the first section of the radial grooves depicted, for example, in FIG. 5 are associated with the door height and, in particular, the vertical height of the vertical door track and attached arcuate track versus the height of the door. The functionality associated with this arrangement insures that upon initial efforts to raise the door vertically from the closed to the open position, a maximum amount of energy is directed to the initial lifting effort. That effort is then attenuated by the groove selection of section 2 (62) which in turn is stabilized and provides for equal radial grooves in section 3 (64), the remainder of the grooved drum construction.

This arrangement also has an important functional aspect with respect to lowering of the door. The amount of energy to initially commence the lowering operation is, of course, lesser because the weight of the door comes into play. Upon reaching the final vertical distance difference between the door opening and track thereof with respect to the lowering of the door provides an increased level of energy during the final inch or so of lowering the door. This arrangement thus functions to prevent the door from engaging the bottom surface or edge of the door at an unwarranted speed or impact. A seal may be fitted on the bottom edge or side of the door which will absorb some of the shock of lowering the door. However, by arranging the sections of the cable drum in the manner described, the energy associated with the lowering of the door is controlled in a manner which will tend to, and will, preclude the lower end of the door from impacting adversely against the surface at the bottom of the door track and opening on the surface of the door opening.

Thus, the construction of the cable drum accommodates issues arising with the initial lifting of the door and perhaps more importantly, the closing of the door in each instance providing energy associated with opening and closing that controls carefully the manner in which the door moves upwardly to a generally horizontal position and downwardly.

The arrangement of the multiple sections of the cable channel or groove thus provides enhanced control by dividing the channel into three discrete sections which interface with each other beginning with a generally fixed level of or slightly declined but increased level of force which then enters into a second section of the groove where the grooves are increasing in radius and ultimately the maximum radius section 3 (64) of the cable drum. This conserves energy and improves safety.

While there has been set forth a preferred embodiment of the invention, it is to be understood that the invention is limited only by the following claims and equivalents thereof.

What is claimed is:

1. A cable drum construction for use in combination with a door cable of a door lift assembly, said cable having a first end attached to the cable drum and a second end attached to a lower end of a multiple, horizontal panel door, said door characterized by a vertical height when closed and mounted on a track assembly, said door moveable on said track assembly between an open position and a substantially vertical closed position, said track assembly including a vertical section for maintaining said garage door in a closed condition and a generally horizontal overhead section joined to said vertical section by an arcuate section, said vertical section and a portion of said arcuate section in combination having a vertical track height greater than the garage door first vertical height, said cable drum construction comprising in combination:
a generally cylindrical body section having a centerline axis of rotation mount for attachment to a rotation shaft, said drum body section including an outer surface with a spiral, generally uniform cross sectional configuration groove winding slot for a said cable, said groove slot located between a first end flange and an axially spaced second end flange separated by said groove slot, said first flange including an attachment location for attaching a said cable first end, said groove slot characterized by a radial dimension between the axis and the groove slot, said spiral groove slot comprising three connected groove slot sections including a first section located adjacent said first flange side of said drum wherein the radial dimension of the groove slot decreases generally uniformly from the first flange axially toward the second flange to a second section increases generally uniformly axially from the first section to a third section, maintains a substantially uniform radial dimension from the second section axially toward the second flange, said third section radial dimension being greater than the radial dimensions of the first and second sections whereby said first section of said drum provides a controlled torque to initiate opening of a said garage door from a vertical closed position and to close a said garage door to a fully closed vertical position.

2. The drum of claim 1 wherein the drum is mounted on a shaft for rotation about the drum axis.

3. The drum construction of claim 2 wherein the shaft is rotationally driven.

4. The drum of claim 2 wherein the shaft is rotationally biased by a spring mechanism.

5. The drum of claim 3 wherein a first drum is combined with a second drum separately mounted on the shaft, said first and second drums having counter spiral grooves.
